(19) United States
(12) Patent Application Publication
(10) Pub. No.: US 2005/0111907 A1
(43) Pub. Date: May 26, 2005

(54) Ball joint

(76) Inventor: Brian A. Urbach, Rochester Hills, MI (US)

Correspondence Address: MACMILLAN, SOBANSKI & TODD, LLC, ONE MARITIME PLAZA - FOURTH FLOOR, 720 WATER STREET, TOLEDO, OH, 43604, US

(21) Appl. No.: 10/720,789

(22) Filed: Nov. 24, 2003

(51) Int. Cl. F16D 1/12

(52) U.S. Cl. 403/122

(57) ABSTRACT

This invention relates to a ball joint (10). The ball joint (10) includes a socket (12) having at least one opening (20) and an inner chamber (22). A bearing assembly (24) is disposed in the chamber (22) of the socket (12). The ball joint (10) also includes a ball stud (28) having a central ball portion (26) and a stud portion (77). The bearing assembly (24) supports the ball portion (26) of the ball stud (28). A resilient bushing (130) is disposed in the chamber (22) and is fixedly attached to the stud portion (77) of the ball stud (28).

### BACKGROUND OF THE INVENTION

This invention relates in general to vehicle steering or suspension systems and in particular to an improved ball joint for use in such a motor vehicle steering or suspension system.

Ball joints provide an articulated connection between two relatively movable parts. Ball joints are commonly used in motor vehicle steering systems and in motor vehicle suspension systems.

In a vehicle steering system, ball joints are commonly adapted to be connected to a steering arm of each of a wheel knuckle. Typically, a ball joint for a motor vehicle steering system includes a ball stud with a spherical ball end and a socket member with a spherical socket. A bearing member in the socket receives the ball end and supports the ball end for rotational and pivotal movement.

In vehicle steering gears, it is known to provide a spring to return the steered wheels to a normal or a straight ahead condition when the steering wheel is released or in the event of a vehicle electrical failure. However, such steering gears can be undesirably bulky and expensive.

It would therefore be desirable to provide an improved structure for returning the steered wheels to a normal or a straight ahead condition when the steering wheel is released or in the event of a vehicle electrical failure.

### SUMMARY OF THE INVENTION

The present invention relates to a ball joint. The ball joint includes a socket having at least one opening and an inner chamber. A bearing assembly is disposed in the chamber of the socket. The ball joint also includes a ball stud having a central ball portion and a stud portion. The bearing supports the ball portion of the ball stud. A resilient bushing is disposed in the chamber and is fixedly attached to the stud portion of the ball stud. Preferably, the bushing is disposed in the chamber such that an outer surface of the bushing cannot move relative to the surface of the chamber.

Other advantages of this invention will become apparent to those skilled in the art from the following detailed description of the invention, when read in light of the accompanying drawings.

### BRIEF DESCRIPTION OF THE DRAWINGS

FIG. 1 is a view, partially in section, of a ball joint constructed in accordance with the present invention and showing a first embodiment of a ball stud.

FIG. 2 is a sectional view of the ball joint illustrated in FIG. 1 taken along line 2-2 of FIG. 1.

FIG. 3 is an exploded view, partially in section, of parts of the ball joint illustrated in FIG. 1.

FIG. 4 is an elevational view of a second embodiment of a ball stud for use in the ball joint illustrated in FIG. 1.

### DETAILED DESCRIPTION OF THE INVENTION

Referring now to FIGS. 1 through 3, there is illustrated a ball joint 10 constructed in accordance with the present invention. The ball joint 10 embodying the present invention may be used in a variety of applications. The ball joint 10 interconnects relatively movable parts, such as a tie rod (not shown) or control arm and a wheel knuckle (not shown) of a vehicle.

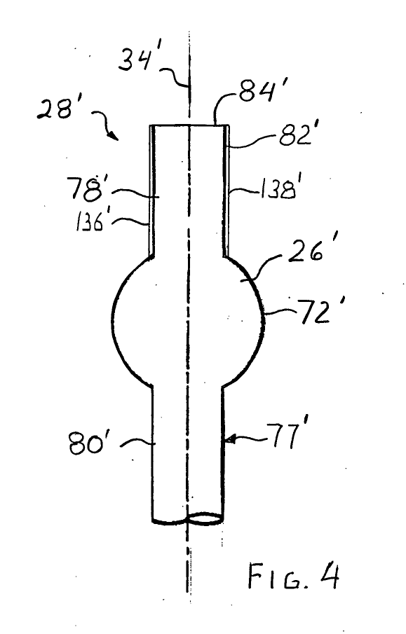

The ball joint 10 includes a substantially rigid socket 12 having a generally cylindrical side wall 14 and a mounting flange 16. The socket 12 includes a closed end 18 and an open end 20, and defines a socket chamber 22. The open end 20 of the socket 12 includes a crimpable flange portion 84. The flange portion 84 includes a remote end 84A shown in a first or uncrimped position in FIG. 3 and a second or crimped position in FIG. 1. The socket 12 is made by a suitable process from a suitable material. For example, the socket 12 can be cold formed or screw machined from SAE grade 1008 or 1010 steel. Alternately, the socket 12 can be made from other materials, such as, for example, other metals and non-metals. Also, the construction of the socket 12, such as the construction of the mounting flange 16 and/or the flange portion 84, can be other than illustrated if so desired.

A bearing assembly 24 is disposed within the socket chamber 22 and includes first and second bearings 30 and 32. The first and second bearings 30 and 32 are generally annular and are centered on a longitudinal axis 34 of the socket 12. The bearings 30 and 32 are made of any suitable material, but preferably are made of injection molded Delrin brand plastic which is available from E. I. DuPont de Nemours & Co.

The first bearing 30 has first and second end portions 36 and 38, respectively, as best shown in FIG. 3. The first bearing 30 includes an outer surface 40 and an inner surface 42. In the illustrated embodiment, the outer surface 40 is generally cylindrical shaped and the inner surface 42 is generally hemispherical shaped. The first end portion 36 has a first surface 44 which extends radially from the inner surface 42 of the first bearing 30 to the outer surface 40. A first opening 46 in the first bearing 30 is defined by the intersection of the first surface 44 and the inner surface 42.

The second end portion 38 of the first bearing 30 has a second surface 48 which extends from the outer surface 40 to a third surface 50 which extends axially from the second surface 48 to the inner surface 42 and which is generally parallel to the outer surface 40. The third surface 50 defines a second opening 52 in the first bearing 30. The diameter of the second opening 52 in the second end portion 38 of the first bearing 30 is smaller than the diameter of the first opening 46 at the first end portion 36 of the first bearing 30.

The second bearing 32 is identical in construction to the first bearing 30. The second bearing 32 has first and second end portions 54 and 56, respectively. A cylindrical outer surface 58 and a generally hemispherical inner surface 60 extend between the end portions 54 and 56 of the second bearing 32. The first end portion 54 has a first surface 62 which extends radially from the inner surface 60 of the second bearing 32 to the outer surface 58. A first opening 64 in the second bearing 32 is defined by the intersection of the first surface 62 and the inner surface 60.

The second end portion 56 of the second bearing 32 has a second surface 66 which extends from the outer surface 58 to a third surface 68 which extends axially from the second surface 66 to the inner surface 60 and which is generally parallel to the outer surface 58. The third surface 68 defines a second opening 70 in the second bearing 32. The bearing assembly 24 supports a central ball portion 26 of a first embodiment of a ball stud 28 for movement relative to the socket 12.

The central ball portion 26 of the ball stud 28 is centered on the longitudinal axis 34. The central ball portion 26 has a substantially spherical shaped outer surface 72. The central ball portion 26 further includes a cylindrical shaped inner surface 73 which defines a central passage 75 through the central ball portion 26.

The ball stud 28 further includes a stud 77 having first and second stud portions 78 and 80, respectively, and a cylindrical shaped outer surface 82. The stud 77 is slidably mounted within the passage 75 and is centered on the longitudinal axis 34. Preferably, the first stud portion 78 extends outwardly from one end of the passage 75 (upwardly as viewed in FIG. 1), and the second stud portion 80 extends outwardly from the opposite end of the passage 75 (downwardly as viewed in FIG. 1). The first stud portion 78 has a planar end surface 84 which is generally perpendicular to the axis 34. Preferably, the first stud portion 78 includes first and second keys 136 and 138, respectively, extending outwardly and longitudinally from opposite sides of the outer surface 82 of the first stud portion 78. The second stud portion 80 further projects through the open end 20 of the socket 12. The ball stud 28 is preferably cold headed or screw machined and then carburized. The ball stud 28 is made of SAE grade 8115M or 8615 steel which is available from LTV Steel. The keys 136 and 138 can be formed by any suitable process. Preferably, the keys 136 and 138 are machined. Alternatively, the construction of the ball stud 28 can be other than illustrated if so desired.

The ball joint 10 includes a seal 100 for closing and sealing the open end 20 of the socket 12. The seal 100 is generally annular and centered on the longitudinal axis 34. The seal 100 is preferably made of suitable elastomeric material, such as for example, Neoprene which is available from Dupont. Alternately, the seal 100 can be made be made of other suitable materials if so desired.

As best shown in FIG. 3, the seal 100 includes a stud seal portion 102 and a bearing seal portion 104 which are connected by a connector portion 106. The stud seal portion 102 includes an axially extending surface 108 which defines a passage 110 for receiving the second stud portion 80 of the ball stud 28. A spring ring 112 is generally L-shaped in cross-section and is preferably injection molded in the stud seal portion 102 of the seal 100 and is embedded in the stud seal portion 102. The spring ring 112 exerts a radially inward biasing force on the stud seal portion 102 of the seal 100.

The bearing seal portion 104 includes first and second surfaces 114 and 116 which extend radially and third and fourth surfaces 118 and 120 which extend axially. The connector portion 106 of the seal 100 connects with the second surface 116 of the bearing seal portion 104.

An annular metal retaining ring 122 is preferably injection molded in the bearing seal portion 104 of the seal 100. The retaining ring 122 is generally square in cross-section and is surrounded on all four sides by the elastomeric material of the bearing seal portion 104. Alternatively, the construction of the seal 100 can be other than illustrated if so desired.

A generally cylindrical resilient member or bushing 130 includes a longitudinal bore 132 centered on the longitudinal axis 34. The resilient bushing 130 is preferably made of neoprene or natural rubber. Alternately, the resilient bushing 130 can be formed from other suitable materials if so desired, such as for example, other elastomers and other resilient materials. As will be discussed below, the bushing 130 is formed from a suitable material having a predetermined hardness for a purpose discussed below.

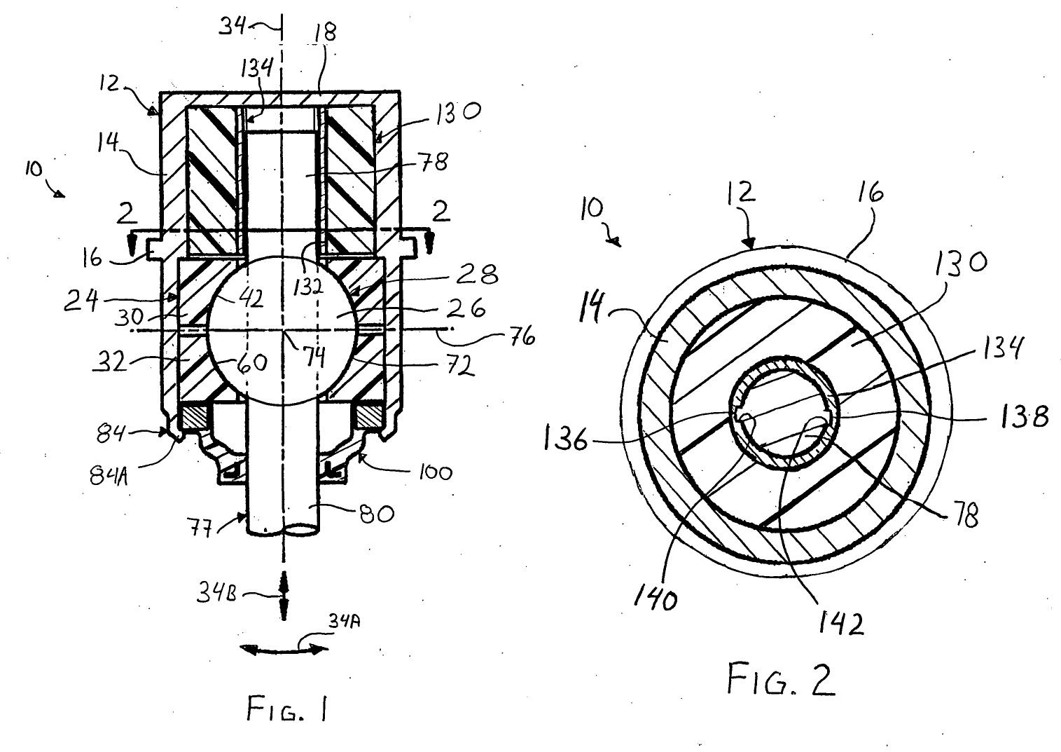

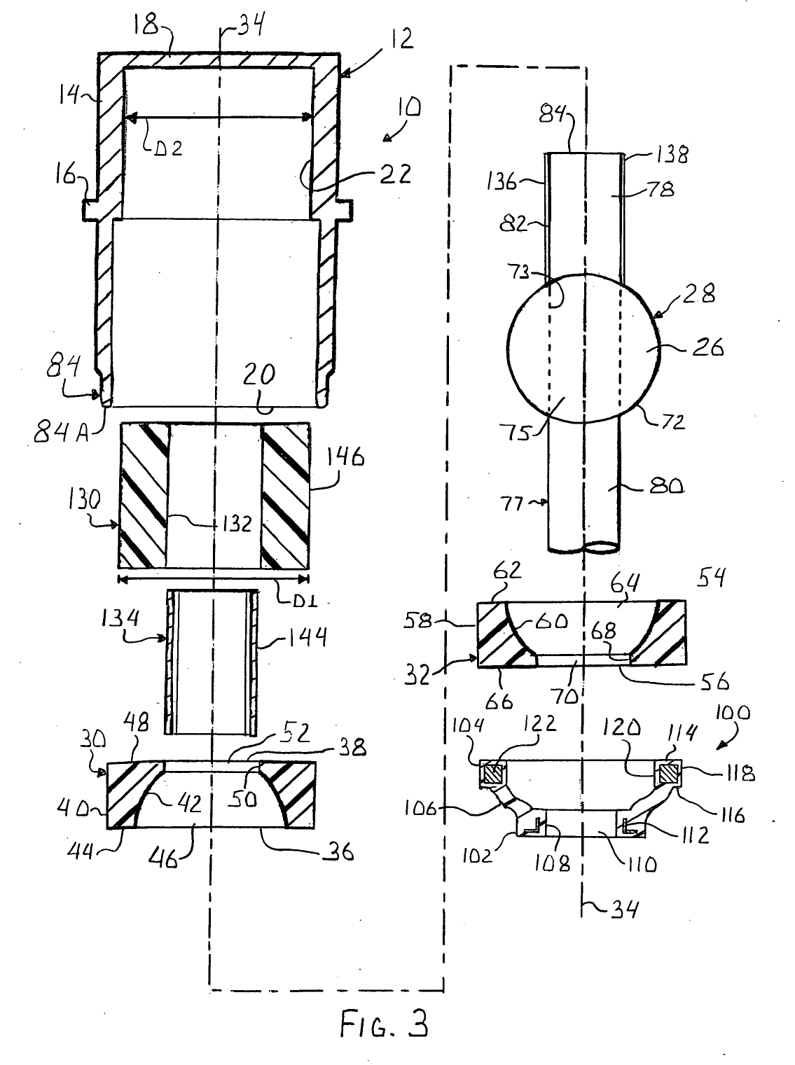

A generally cylindrical sleeve 134 is disposed within the bore 132. The sleeve 134 includes first and second keyways 140 and 142 extending longitudinally on opposite sides of an inner surface of the sleeve 134. The keyways 140 and 142 are positioned so as to receive the keys 136 and 138, respectively, of the first stud portion 78, as shown in FIG. 2. The sleeve 134 can be made by any suitable process from any suitable material. For example, the sleeve 134 can be stamped or machined, and made from any suitable grade of steel or aluminum. Alternately, the sleeve 134 can be made of other material, such as for example, other metals or non-metals. It will further be appreciated that, if desired, the first stud portion 78 can be formed with keyways to receive keys formed on the inner surface of the sleeve 134.

The resilient bushing 130 is preferably bonded to an outer surface 144 of the sleeve 134. Preferably, the resilient bushing 130 is formed about the outer surface 144 of the sleeve 134 under sufficient heat and pressure so as to bond the material of the resilient bushing 130 to the sleeve 134. The resilient bushing 130 can be bonded to the sleeve 134 by any suitable method, such as by injection molding. If desired, an adhesive can be applied to the outer surface 144 of the sleeve 134 prior to injection molding to provide a chemical bond between the sleeve 134 and the resilient bushing 130. Any suitable adhesive can be used, such, as for example resorcinal-formaldehyde-latex (RFL) in an aqueous solution, which is available from Lord Chemical or Dupont. Alternately, any other suitable adhesives can be used.

The central ball portion 26 of the ball stud 28 is supported within the bearing assembly 24 for limited pivoting movement about a center of oscillation 74. As used herein, the center of oscillation 74 is the intersection of the longitudinal axis 34 and a transverse axis 76 of the central ball portion 26. The center of oscillation 74 is coincident with the center of the central ball portion 26 of the ball stud 28. The stud 77 is mounted within the central ball portion 26 for limited rotational or torsional movement about the longitudinal axis 34, as shown by an arrow 34A, and limited axial movement along the longitudinal axis 34, as shown an arrow 34B, and as described in detail herein.

Preferably, an outer diameter D1 of the resilient bushing 130 is slightly larger than an inner diameter D2 of the socket chamber 22, such that an outer surface 146 of the resilient bushing 130 will not slide against or otherwise move relative to the inner surface of the socket chamber 22 during normal steering operation. If desired, an adhesive can be applied to the inner surface of the socket chamber 22 prior to inserting the resilient bushing 130 to provide a chemical bond between the outer surface 146 of the resilient bushing 130 and the inner surface of the socket chamber 22 to prevent any relative movement therebetween. Any suitable adhesive can be used, such, as for example resorcinal-formaldehyde-latex (RFL) in an aqueous solution. Alternately, any other suitable adhesive can be used.

In the assembled and installed condition of the ball joint 10, the socket 12 is preferably attached to a receiving member, such as a vehicle control arm (not shown). Preferably, the receiving member includes a generally cylindrical opening for receiving the cylindrical outer side wall 14 of the socket 12. The socket 12 is fixedly secured to the receiving member by any suitable method, such as with threaded fasteners, or press-fitting and/or welding the socket 12 to the receiving member.

One advantage of the present invention is that the resilient bushing 130 functions as a biasing member or spring for providing a restoring or centering force on the ball joint 10. The centering force causes the steerable vehicle wheels to return to a normal or a straight ahead condition when a force, such as the force applied by the turning of the vehicle steering wheel, is released or during a vehicle electrical failure. As described above, the ball stud 28 can oscillate about the center of oscillation 74 with respect to the ball portion 26. The resilient bushing 130 further provides for limited rotational or torsional movement of the stud 77 about the longitudinal axis 34. Because the stud 77 is slidably mounted within the central ball portion 26 and within the sleeve 134, limited axial movement of the stud 77 relative to the central ball portion 26 is also possible. The centering force, as determined by the predetermined hardness of the resilient bushing 130, is operative to cause the stud 77 to return to the normal position, as viewed in FIG. 1, when the steering wheel is released by the vehicle operator or when a vehicle power failure occurs.

Another advantage of the ball joint 10 of the present invention is that when it is used in a four wheel steering vehicle application, a corresponding rear wheel steering gear can be provided without a return or centering spring thereby reducing the size and cost of such a steering gear. Because the resilient bushing 130 of the present invention functions as a return spring as described above, no such return spring is necessary in the rear wheel steering gear of the vehicle.

If it is desired to provide a ball joint having the characteristics of the ball joint 10, but wherein axial movement of the stud 77 is not necessary or desired, then a second embodiment of a ball stud, indicated generally at 28′ in FIG. 4, can be used. As shown therein and using like reference numbers to indicate corresponding parts, the ball stud 28′ includes a central ball portion 26′ which is centered on a longitudinal axis 34′. The central ball portion 26′ has a substantially spherical shaped outer surface 72′. The ball stud 28′ further includes a stud 77′ having first and second stud portions 78′ and 80′, respectively. In this embodiment, the stud 77′ is formed integral with the central ball portion 26′ as a single unit. Alternatively, the stud 77′ can be formed separate from the central ball portion 26′ and fixedly secured thereto by suitable means. Preferably, the first stud portion 78′ extends outwardly from one end of the central ball portion 28′ (upwardly as viewed in FIG. 4), and includes first and second keys 136′ and 138′, respectively, extending outwardly and longitudinally from opposite sides of an outer surface 82′ thereof.

The second stud portion 80′ preferably extends outwardly from the central ball portion 28′, opposite the first stud portion 78′ (downwardly as viewed in FIG. 4). The first stud portion 78′ has a planar end surface 84′ which is generally perpendicular to the axis 34′. Thus, it can be seen that other than the stud 77′ in this embodiment not being capable of axial movement relative to the central ball portion 26′, the structure and operation of the ball stud 28′ is otherwise identical to that of the ball stud 28.

If desired, the resilient bushing 130 can be bonded to the first stud portion 78′, thereby eliminating the need for a sleeve 134. Preferably, the resilient bushing 130 is formed about an outer surface of the first stud portion 78′ under sufficient heat and pressure so as to bond the material of the resilient bushing 130 to the first stud portion 78′. The resilient bushing 130 can be bonded to first stud portion 78′ by any suitable method, such as by injection molding. If desired, an adhesive can be applied to the outer surface of the first stud portion 78′ prior to injection molding to provide a chemical bond between the sleeve 134 and the first stud portion 78′. Any suitable adhesive can be used, such, as for example resorcinal-formaldehyde-latex (RFL) in an aqueous solution, which is available from Lord Chemical or Dupont. Alternately, any other suitable adhesives can be used.

The principle and mode of operation of this invention have been described in its preferred embodiments. However, it should be noted that this invention may be practiced otherwise than as specifically illustrated and described without departing from its scope.

1. A ball joint comprising:
a socket having at least one opening and an inner chamber;
a bearing assembly disposed in said chamber of said socket;
a ball stud having a central ball portion and a stud portion, said ball portion supported by said bearing assembly; and
a resilient bushing disposed in said chamber and fixedly attached to said stud portion of said ball stud.

2. The ball joint according to claim 1, wherein said bushing is disposed in said chamber such that an outer surface of said bushing cannot move relative to the surface of said chamber.

3. The ball joint according to claim 1, wherein said ball portion of said ball stud has a bore formed therethrough and said stud portion is disposed within said bore.

4. The ball joint according to claim 1, wherein said bushing is has a longitudinal bore formed therethrough, and wherein a sleeve is disposed in said bore of said bushing.

5. The ball joint according to claim 4, wherein said sleeve is fixedly attached to said bushing.

6. The ball joint according to claim 4, wherein said sleeve is fixedly attached to said bushing with an adhesive.

7. The ball joint according to claim 4, wherein said stud portion is slidably disposed in said sleeve.

8. The ball joint according to claim 4, wherein said stud portion further includes at least one key provided on an outer surface thereof and said sleeve includes at least one keyway provided on an inner surface thereof, and wherein said key of said stud portion is slidably disposed in said keyway of said sleeve.

9. The ball joint according to claim 1, wherein said ball portion of said ball stud has a first axis and second axis transverse to the first axis, an intersection of the first axis and the second axis defining a center of oscillation, wherein said ball portion is normally centered on the center of oscillation.

10. The ball joint according to claim 9, wherein said resilient bushing is formed of a material having a predetermined hardness to thereby apply a restoring force to maintain or return said ball stud to the normally centered position.

11. The ball joint according to claim 1, further including a seal for sealing said at least one opening of said socket.

12. The ball joint according to claim 1, wherein said bearing assembly includes first and second spaced apart bearings members for supporting said ball portion of said ball stud.

13. The ball joint according to claim 1, wherein said resilient bushing is formed from one of rubber and neoprene.

14. A ball joint for a vehicle having steering wheel, said ball joint comprising:
a socket having at least one opening and an inner chamber;
a bearing assembly disposed in said chamber of said socket;
a ball stud having a central ball portion and a stud portion, said ball portion supported by said bearing assembly; and
a resilient bushing disposed in said chamber and fixedly attached to said stud portion of said ball stud, wherein said ball portion has a first axis and second axis transverse to the first axis, an intersection of the first axis and the second axis defining a center of oscillation, wherein said ball portion is normally centered on the center of oscillation, and wherein said resilient bushing is formed of a material having a predetermined hardness to thereby apply a restoring force to maintain or restore said ball stud to the normally centered position.

15. The ball joint according to claim 14, wherein said bushing is disposed in said chamber such that an outer surface of said bushing cannot move relative to the surface of said chamber.

16. The ball joint according to claim 14, wherein said ball portion of said ball stud has a bore formed therethrough and said stud portion is disposed within said bore.

17. The ball joint according to claim 14, wherein said bushing is has a longitudinal bore formed therethrough, and wherein a sleeve is slidably disposed in said bore of said bushing.

18. The ball joint according to claim 14, wherein said sleeve is fixedly attached to said bushing.

19. The ball joint according to claim 14, wherein said stud portion further includes at least one key provided on an outer surface thereof and said sleeve includes at least one keyway provided on an inner surface thereof, and wherein said key of said stud portion is slidably disposed in said keyway of said sleeve.

20. A tie rod end adapted for use in a vehicle having a steering wheel for controlling steerable wheels, said tie rod end comprising:
a socket having at least one opening and an inner chamber;
a stem extending outwardly from said socket;
a bearing assembly disposed in said chamber of said socket;
a ball stud having a central ball portion and a stud portion, said ball portion supported by said bearing assembly, wherein said ball portion has a first axis and second axis transverse to the first axis, an intersection of the first axis and the second axis defining a center of oscillation, wherein said ball portion is normally centered on the center of oscillation; and
a resilient bushing disposed in said chamber and fixedly attached to said stud portion of said ball stud, wherein said resilient bushing is formed of a material having a predetermined hardness to thereby apply a restoring force to maintain or restore said ball stud to the normally centered position, and wherein when a torsional force is applied to said ball stud by turning of a vehicle steering wheel, said ball stud is caused to rotate about the first axis.
